(19) United States
(12) Patent Application Publication
(10) Pub. No.: US 2026/0126907 A1
(43) Pub. Date: May 7, 2026

(54) Semiconductor Apparatus, Semiconductor Device, Non-Transitory Computer-Readable Medium, Method, Apparatus, and Device for a Computer System

(71) Applicants: Tuan QUACH, San Clemente, CA (US); Kermin CHOFLEMING, JR., Hudson, MA (US); William LEE, Sherwood, OR (US)

(72) Inventors: Tuan QUACH, San Clemente, CA (US); Kermin CHOFLEMING, JR., Hudson, MA (US); William LEE, Sherwood, OR (US)

(21) Appl. No.: 19/428,416

(22) Filed: Dec. 22, 2025

Related U.S. Application Data
(60) Provisional application No. 63/913,185, filed on Nov. 7, 2025.

(51) Int. Cl. G06F 3/06

(52) U.S. Cl. CPC G06F 3/0604; G06F 3/0656; G06F 3/0679

(57) ABSTRACT

Various examples relate to a semiconductor apparatus, a semiconductor r device, or to a non-transitory computer-readable medium, a method, an apparatus or a device for a computer system, and to a computer system comprising the semiconductor apparatus and the apparatus or device. A semiconductor apparatus comprises a spatial array of processing elements coupled by an interconnect network, a plurality of memory management circuits coupled to the spatial array of processing elements, wherein the respective memory management circuits comprise a first buffer circuit for storing a configuration to be used for configuring the processing elements associated with the respective memory management circuit and a second buffer circuit for storing results of computations performed by the processing elements associated with the respective memory management circuit, the first buffer circuit being separate from the second buffer circuit.

### BACKGROUND

Spatial accelerators, such as the Intel® Configurable Spatial Accelerator (CSA), are specialized hardware architectures designed to improve performance and energy efficiency for specific computational workloads. Unlike traditional processors that execute instructions sequentially, spatial accelerators implement computation by mapping dataflow graphs directly onto reconfigurable hardware fabric. These accelerators typically comprise an array of processing elements (PEs) interconnected through a configurable network, allowing data to flow spatially across the architecture rather than being shuttled back and forth to memory.

Programs are executed on spatial accelerators by first compiling the high-level code into a dataflow graph representation that explicitly captures the parallelism and data dependencies in the computation. This dataflow graph is then mapped onto the accelerator's fabric, where nodes become processing elements and edges become data channels. The compiler configures the accelerator hardware to implement the specific operations and routing required for the program. During execution, data streams through the configured fabric in a pipelined fashion, with multiple operations proceeding concurrently as data becomes available, thus eliminating much of the overhead associated with instruction fetch and decode in traditional architectures.

Configurable architectures, such as spatial accelerators, differ from Von Neumann architectures in that they have a discrete configuration operation, as opposed to being reconfigured on each instruction decoding. Making configuration faster is a key figure of merit in these architectures, as it increases the number of scenarios in which they can be deployed.

### BRIEF DESCRIPTION OF THE FIGURES

Some examples of apparatuses and/or methods will be described in the following by way of example only, and with reference to the accompanying figures, in which:

FIG. 1a shows a schematic diagram of a tile of a spatial accelerator semiconductor apparatus or semiconductor device;

FIG. 1b shows a schematic diagram of a computer system comprising a spatial accelerator semiconductor apparatus or semiconductor device with a plurality of tiles;

FIG. 1c shows a flowchart of a method for a computer system;

FIGS. 2a and 2b show illustrations of completion buffer microarchitecture alternatives;

FIG. 3 shows a diagram of an example of the physical organization of a configuration completion buffer;

FIG. 4 shows a timing diagram depicting result-based triggering in combination with the configuration prefetching enabled by a separate completion buffer;

FIG. 5 shows an illustration of result broadcast regions for sub-tiles;

FIG. 6 shows an illustration of t_{delay} relative to an existing execution;

FIG. 7 shows t_{delay} vs. observed configuration latency assuming a perfect CSA cache;

FIG. 8 shows t_{delay} vs. observed configuration latency assuming no cache locality and configuration is off-chip;

FIG. 9 shows an observed configuration latency vs. completion buffer entries, assuming a perfect CSA cache;

FIG. 10 shows observed configuration latency vs. completion buffer entries, assuming configuration is in on-chip memory;

FIG. 11 shows a block diagram of a RAF with separate buffers;

FIG. 12 shows a timing flow; and

FIG. 13 shows a schematic diagram of a computer system.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

Various examples of the present disclosure relate to a split configuration architecture. Such a split configuration architecture enables the configuration of a subsequent subprogram to be fetched while a current subprogram is executing, allowing much of the latency of the fetching operation to be hidden underneath program execution.

Some spatial accelerators use a unified configuration architecture in which buffers are shared between program execution and configuration, so that the two tasks have be performed serially. This results in increased configuration latency.

The present disclosure introduces a separate configuration data buffer in the memory interface structure, allowing configuration data to be fetched while another program is executing. This eliminates most memory hierarchy latencies associated with program switching and allows achieving observed switching latencies on the order of tens of nanoseconds.

The proposed concept results in an improvement to cache performance caused by reducing data conflicts. Skew caches work more effectively for smaller and lower associativity caches. Therefore, the proposed concept is particularly applicable for future smaller cache designs between the current first-level and second-level caches.

The present disclosure uses separate memory structures. Observed configuration latencies are dependent on the use of the separate configuration buffer. For example, this separation of buffers may be revealed to the upper levels of the software stack, so that the software stack can make use of it.

The present disclosure relates to a semiconductor apparatus or semiconductor device, e.g., a spatial accelerator semiconductor apparatus or semiconductor device, engineered for high-performance computing. For example, the proposed semiconductor apparatus may be implemented on the Intel® Configurable Spatial Accelerator (CSA) platform. The architecture of the proposed semiconductor apparatus, which may be implemented similar to the CSA, is a departure from traditional processors that execute a linear sequence of instructions. Instead, this apparatus is designed to be physically configured to directly mirror the structure of a computation, allowing for massive parallelism.

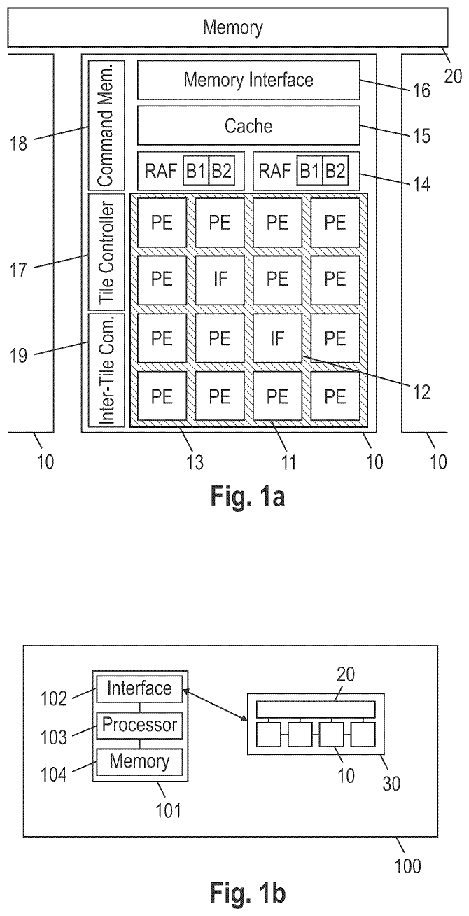

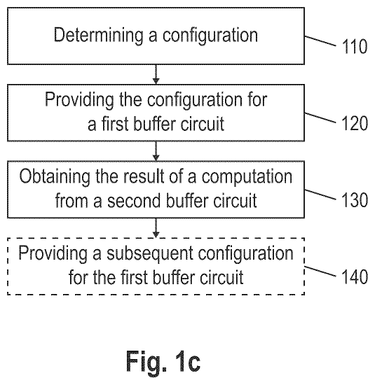

FIG. 1a shows a schematic diagram of a tile 10 of a spatial accelerator semiconductor apparatus or semiconductor device. The tile comprises a spatial array of processing elements (PE) 11, which are interconnected by an interconnect network 13 (e.g., a communications network). In addition to the processing elements 11, the interconnect network 13 may also connect interface elements (IF) 12 to the processing elements, to enable communication with other devices. The tile further comprises a RAF (Request Address File) 14, which is also referred to as memory management circuitry or means for memory management, which manages memory accesses by the processing elements 11. The tile further comprises a cache 15 and a memory interface 16, with the RAF 14 coordinating the access to memory 20 via the memory interface 16 and the cache 15. As further optional components, the tile comprises a tile controller 17, which may be used to configure the PEs 11 and interconnect network 13, e.g., with the help of the RAF 14, a command memory 18, and an inter-tile communication interface 19, which enables communication between the tiles 10 of the spatial accelerator semiconductor apparatus or semiconductor device. The tile controller 17 may serve as interface circuitry or interface for obtaining a dataflow graph comprising a plurality of nodes, which defines the functionality of the spatial accelerator semiconductor apparatus or semiconductor device. The interconnect network 13 is coupled to the processing elements and configured to receive an input of the dataflow graph. In particular, the dataflow graph is to configure the interconnect network 13 and the plurality of processing elements 11. The processing elements 11 are to perform a plurality of operations defined by the nodes of the dataflow graph.

FIG. 1b shows a schematic diagram of a computer system 100 comprising a spatial accelerator semiconductor apparatus 30 or semiconductor device 30 with a plurality of tiles 10 and a memory 20. In addition to the spatial accelerator semiconductor apparatus 30 or semiconductor device 30, the computer system 100 comprises a conventional apparatus or device 101 comprising an interface circuitry 102 or means for communicating 102, processor circuitry 103 or means for processing 103, and memory circuitry 104 or means for storing information 104. The apparatus 101 comprises circuitry configured to perform its functionality. In particular, the apparatus 101 comprises the interface circuitry 102, the processor circuitry 103, and the memory circuitry 104. The processor circuitry 103 is coupled with the interface circuitry 102 and the memory circuitry 104, and is configured to provide the functionality of the apparatus 101, with the help of the interface circuitry 102 (for exchanging information, e.g., with the semiconductor apparatus 30) and the memory circuitry 104 (for storing information, such as machine-readable instructions or the dataflow graph). For example, the processor circuitry 103 may be configured to execute machine-readable instructions that define the functionality performed by the apparatus 101. Similarly, the components of the device 101 are defined as component means, which may be implemented by the corresponding components of the apparatus 101. The functionality of the device 101 may be substantially the same as the functionality of the apparatus 101.

The fundamental programming abstraction for the spatial accelerator semiconductor apparatus 30, or device 30, is the dataflow graph. This graph is a formal representation of a program, where the task is broken down into a collection of nodes and edges. The nodes represent specific operations, such as an arithmetic calculation, a logical comparison, or a memory access. The edges connecting these nodes represent the dependencies between them, dictating the path that data follows. For instance, an edge from a “load” node to an “add” node signifies that the data retrieved from memory is required for the addition operation. This model makes the inherent parallelism of an application explicit.

The physical hardware of the apparatus is designed to execute the dataflow graph. The spatial accelerator semiconductor apparatus or device comprises a plurality of processing elements (PEs) 11, e.g., a spatial array of processing elements. These are the computational circuits performing the computational tasks of the system, each responsible for executing the operation of a single node of the dataflow graph. The PEs are often heterogeneous, meaning they can be specialized for different types of tasks (e.g., some for floating-point math, others for integer logic).

Connecting these processing elements is the interconnect network 13. This network acts as the circulatory system of the apparatus, responsible for routing data between the PEs according to the edges defined in the dataflow graph. A key characteristic of this network is that its communication channels may be implemented “latency-insensitive” and “back-pressured.” This means the system may operate correctly regardless of communication delays, as a PE may automatically pause and wait to send data until the receiving PE has available space. This data-driven, asynchronous model may ensure reliable operation without requiring a global clock to synchronize every action across the chip.

The process of preparing the apparatus for a task is called configuration. During this phase, the dataflow graph is loaded onto the hardware (e.g., using the tile manager 17 and/or the RAFs 14). The definitions for the graph's nodes and edges may be stored in the command memory 18. The configuration process reads this information and uses it to program the individual PEs (by assigning the respective PEs a specific operation to perform) and to set up the data pathways within the interconnect network. Once configured, the spatial accelerator semiconductor apparatus or device is transformed into a specialized hardware circuit custom-built for that specific dataflow graph.

To manage the high volume of memory accesses that occur in such a parallel system, the apparatus may rely on specialized memory interface components. The cache 15 may be employed as a high-speed buffer between the processing elements 11 and the memory 20. It may store frequently accessed data and instructions, thereby reducing the latency of memory operations and keeping the PEs supplied with the data they need to continue operating without stalls. Furthermore, the Request Address File (RAF) circuit 14 may be used to manage the flow of memory requests. In an environment with hundreds or thousands of PEs potentially accessing memory simultaneously, the RAF circuit may act as a traffic controller, orchestrating the memory load and store operations originating from across the PE array, helping to ensure data consistency and manage dependencies between memory accesses.

In various semiconductor apparatuses or devices, the RAF comprises a completion buffer. This buffer serves as a sophisticated ledger for tracking the status of all outstanding memory operations that have been dispatched from the processing elements to the memory system. When a PE initiates a memory request, such as a load or a store, a corresponding entry is created in the completion buffer. This entry effectively monitors the request as it travels through the memory hierarchy. Once the memory operation is fulfilled, e.g., when the requested data is returned for a load operation, the completion buffer is updated to mark that specific request as complete. This mechanism is useful for managing the inherent out-of-order nature of a high-performance memory system. While some memory requests may be serviced quickly (e.g., from a cache hit) and others more slowly (e.g., from main memory), the completion buffer provides the RAF circuit with a definitive record of which operations have finished. This allows the system to ensure data consistency and correctly handle dependencies between different memory accesses, thereby guaranteeing the integrity of the final computation.

The RAF (Request Address File) completion buffer is used to both receive and reorder memory responses for consumption by the graph executing on the fabric of the spatial accelerator. As spatial accelerator configuration is also sourced from the main memory hierarchy, it may pass through a completion buffer.

Various examples of the present disclosure are based on the finding that conventional spatial accelerators with spatial arrays of processing elements face challenges in efficiently managing configuration data and computational results, particularly when transitioning between different computational tasks. Other architectures may experience performance bottlenecks and inefficiencies due to conflicts between configuration loading operations and result retrieval operations, leading to idle processing time and reduced throughput. The present disclosure relates to a technique for improving the efficiency of reconfigurable semiconductor apparatuses by providing separate buffer circuits for configuration data and computational results, thereby enabling overlapped operations and reduced reconfiguration latency.

The proposed concept addresses these challenges by employing memory management circuits (e.g., RAFs) with dedicated buffer circuits that independently handle configuration data and computational results. By separating these data flows, the semiconductor apparatus can receive and buffer subsequent configurations while processing elements are still performing computations according to a present configuration. This improves overall system throughput by eliminating stalls that would otherwise occur when waiting for configuration data to become available. The proposed concept results in enhanced resource utilization and reduced latency in reconfigurable computing architectures, particularly beneficial for applications requiring frequent reconfiguration of processing elements, such as neural network inference, signal processing, and other compute-intensive tasks with dynamic workloads.

In the proposed spatial accelerator semiconductor apparatus or device 30, some aspects of the present disclosure relate to the respective memory management circuits 14 which comprise a first buffer circuit/first buffer B1 for storing a configuration to be used to configure the processing elements associated with the respective memory management circuit and a second buffer circuit/second buffer B2 for storing results of computations performed by the processing elements associated with the respective memory management circuit. The first buffer (circuit) B1 is separate from the second buffer (circuit) B2. By providing separate buffer circuits for configuration and results, efficient parallel handling of configuration loading and result retrieval is achieved, which reduces reconfiguration overhead and improves overall computational throughput.

This buffer configuration is used by the computer system 100 in configuring the spatial accelerator semiconductor apparatus or device. FIG. 1c shows a flowchart of a method for the computer system 100 (which may be performed by the computer system 100, e.g., by the apparatus 101 or device 101 of the computer system 100). The method comprises determining 110 a configuration for the semiconductor apparatus 30. The method comprises providing 120 the configuration for the first buffer circuit B1. The method comprises obtaining 130 the result of the computations of the second buffer circuit B2. By employing separate buffer circuits for configuration and results at the method level, the computer system can efficiently orchestrate configuration distribution and result collection, improving overall system performance. In some examples, the method may further comprise providing 140 a subsequent configuration to the first buffer circuit of the respective memory management circuits while the processing elements associated with the respective memory management circuit are performing computations according to the present configuration.

In the following, the features of the semiconductor apparatus 30, semiconductor device 30, computer system 100, methods, and corresponding computer programs will be discussed in more detail with reference to the semiconductor apparatus 30. Features discussed in connection with the semiconductor apparatus 30 may likewise be included in the corresponding semiconductor device 30, computer system 100, methods, and computer programs.

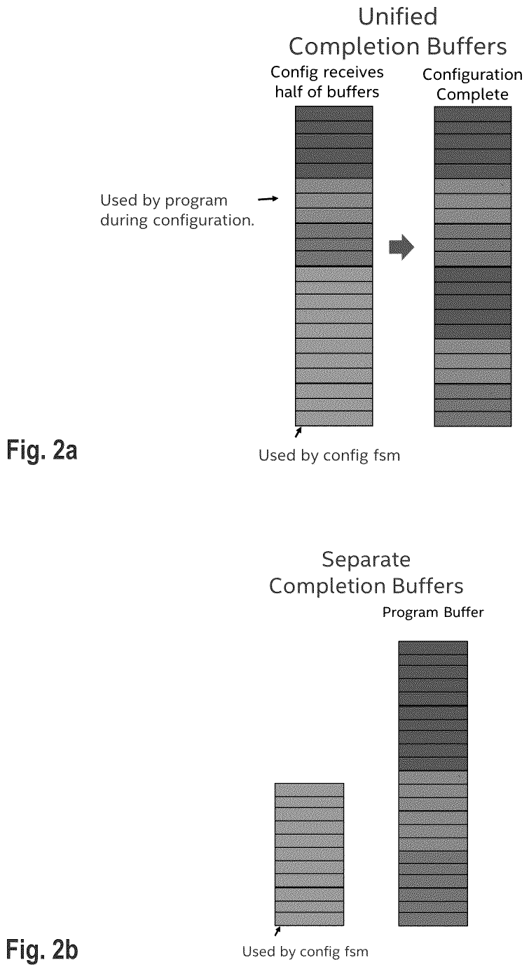

FIGS. 2a and 2b show illustrations of completion buffer microarchitecture alternatives, with FIG. 2a showing unified completion buffers and FIG. 2b showing separate completion buffers. The use of separate completion buffers uses more area, but offers opportunities for parallelism and latency reduction not present in the unified microarchitecture. Unified microarchitecture can allow early execution, but cannot allow early fetching of data. As illustrated in FIG. 2a, the unified buffer is shown to be occupied sequentially, first during the configuration and subsequently during the program time, enforcing a serial workflow. In contrast, FIG. 2b illustrates separate buffers for configuration and program completion. This separation allows the configuration for a subsequent program to be loaded and buffered while the current program is still executing, enabling the overlap of configuration and execution phases.

In the base microarchitecture of other spatial accelerators, a unified completion buffer is used. Such a unified completion buffer uses less area, but may have drawbacks. The unified approach requires that a previously executing graph must have completed execution prior to the commencement of configuration fetching, as the completion buffer structure is shared. Additionally, to allow configuration in parallel with program data accesses, a buffer sharing scheme is used, which mildly increases design complexity.

In the present disclosure, an alternative completion buffer architecture is considered, in which a small, dedicated completion buffer is provisioned for the exclusive use of the RAF configuration facility in addition to the primary completion buffer, the size of which is not changed. The use of a separate completion buffer has several attractive characteristics. As the buffer is not used by the main program, the loading of configuration of the subsequent program can commence as soon as the prior configuration has completed. In other words, to enable seamless transitions between computational tasks, the respective memory management circuits may be configured to receive a subsequent configuration to be applied to the processing elements associated with the respective memory management circuit in a subsequent time interval while the processing elements associated with the respective memory management circuit are performing computations according to a present configuration. This has the effect of prefetching the next configuration underneath current graph execution and into fast memory (similar latency to configuration cache). For enhanced flexibility, the respective memory management circuits may be configured to use the first buffer circuit independently of the second buffer circuit. This independent operation allows configuration data to be loaded, stored, and applied without being blocked by result retrieval operations, and vice versa. The main drawback of separate completion buffers is that they require extra implementation area, although, in a practical implementation the completion buffer (0.3-0.5 KB) is smaller than both the configuration cache (8-16 KB) and the main completion buffer (2 KB). Therefore, to optimize silicon area usage, the first buffer circuit may have a smaller storage capacity than the second buffer circuit, reflecting the observation that configuration data is typically smaller than result data while still providing sufficient buffering for both.

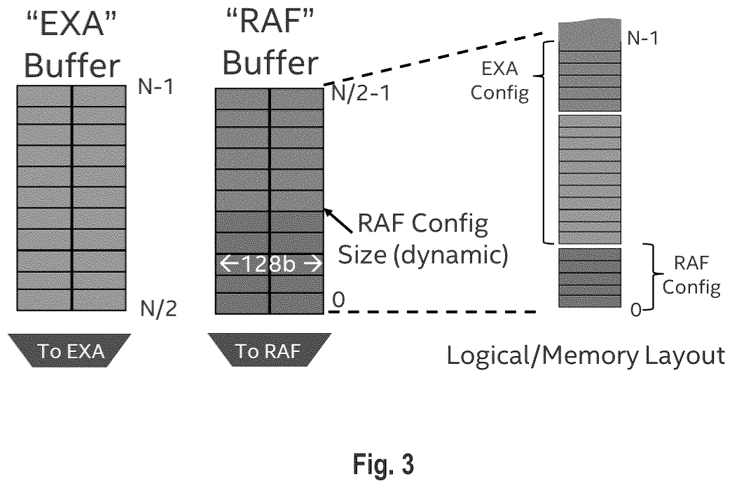

FIG. 3 shows a diagram of an example of the physical organization of a configuration completion buffer. The completion buffer is organized into two banks to allow parallelism in configuring RAF and EXA (Execution Array). FIG. 3 gives a high level overview of the configuration completion buffer microarchitecture. For improved organization, the first buffer circuit may comprise a first and a second buffer bank. The configuration may comprise a first configuration portion relevant for the respective memory management apparatus and a second configuration portion relevant for the processing elements associated with the memory management apparatus. The respective memory management apparatuses may be configured to receive the configuration to be stored in the first and second buffer banks, and to store the first configuration portion in the first buffer bank and at least a portion of the second configuration portion in the second buffer bank. The completion buffer comprises up to N (<64) 64b entries organized into two 128b-wide banks, matching the ACI (Accelerator Cache Interconnect) bandwidth. Accordingly, the first and second buffer banks may have a width that matches the bandwidth of a communication interface, which allows data to be transferred in optimal-sized chunks. As it is expected to be a common case that the configuration cache is populated before the commencement of configuration (e.g. a prefetch), a double bank organization may be used to enable simultaneous configuration of EXA and RAF in parallel, with a bandwidth of 16B per cycle to each. Serialized configuration (e.g. non-prefetched wide branch) remains possible.

In order to realize simultaneous configuration of EXA and RAF, a specific arrangement of data may be used to ensure that RAF and early EXA configuration are not in the same completion buffer bank. This may be achieved by traversing the configuration completion buffer in a logical ordering that differs from the natural physical ordering of the completion buffer. In particular, the length of the RAF configuration may be determined as the configuration is written into the completion buffer. RAF configuration may be written to the first bank. When EXA configuration arrives, it may be written to the second bank. Once the second bank is filled, writing to the first bank resumes, filling the portion of the first bank not occupied by the RAF configuration. In other words, to improve storage utilization, the respective memory management apparatuses may be configured to store the first configuration portion in the first buffer bank, subsequently store the second configuration portion in the second buffer bank until the second buffer bank is filled, and thereafter store a remaining part of the second configuration portion in the first buffer bank. This creates a logical FIFO ordering with three segments: first a portion of the ‘RAF’ buffer, the entire ‘EXA’ buffer, and finally the remainder of the ‘RAF’ buffer, and this ordering is used for the remainder of the configuration. There are a handful of edge cases, mostly around 8-byte data alignment. For example, RAF configuration might not be allowed to be a multiple of 16 bytes. Mux structures are provided to align data. Accordingly, the semiconductor apparatus may comprise multiplexing circuitry configured to align the first and second configuration portions for storage in the first and second buffer banks, ensuring that configuration data is correctly routed.

Various examples of the present disclosure support result-based triggering. The split completion buffer enables configuration to be loaded into the RAF while execution is ongoing, and this loading can and may commence as soon as a prior graph has loaded. However, the configuration cannot be loaded into the spatial accelerator until the prior graph has finished execution. Therefore, to ensure timely and accurate reconfiguration, the respective memory management circuits may be configured to detect that the processing elements associated with the respective memory management circuit have finished performing computations according to a present configuration, and to reconfigure the processing elements associated with the respective memory management circuit with the configuration stored in the first buffer circuit upon detection of the computations finished. There may be three primary conditions for the injection of configuration into the CSA: (1) new configuration is available in the configuration completion buffer, (2) all results from all graph invocations have been returned to the tile manager, and (3) all outstanding memory operations associated with the prior graph have completed. In other words, the detection may be based on one or more of (1) a subsequent configuration being stored in the first buffer circuit, (2) the results of graph invocations having been returned to a managing entity, or (3) outstanding memory operations associated with a present graph having been completed, which allows the apparatus to adapt to different scenarios and ensure reliable synchronization.

Supporting these conditions automatically at the RAF means that configuration injection can commence as soon as the architectural conditions are met, without any software intervention. This shortens the effective idle time between graph executions to a handful (<5) cycles in nearly every use case. FIG. 3 depicts this kind of flow, in which an early initiated configuration is already available in the configuration completion buffer and can begin injecting into the fabric, even before prior graph results have been fully processed. FIG. 3 shows a timing diagram depicting result-based triggering in combination with the configuration prefetching enabled by the separate completion buffer.

For well-formed graphs, conditions (2) and (3) are equivalent as well-formed graphs will return a memory ordering token tied to the completion of outstanding memory operations. However, as this cannot be architecturally enforced, hardware may check for this condition. Conditions (1) and (3) are localized to a particular RAF and may be required in the baseline configuration flow. Condition (2) is new and requires minor support hardware. In other spatial accelerators, result operations may be encoded at the RAF as specialized memory operations, which send results to the tile manager. These may be scheduled like other memory operations and, like all other dataflow operations, based on data availability conditions.

To support condition (2), each RAF may keep a running counter of outstanding results. In other words, the respective memory management apparatuses may comprise a counter of outstanding results, with the detection of the computations being finished being based on the counter of outstanding results. This provides a straightforward and efficient mechanism for determining when all computational tasks have been completed. The counter may be incremented by the number of results expected by the invocation prior to the injection of that configuration's arguments. As RAFs issue result operations, they may inject messages onto a RAF-local broadcast bus. Messages on the broadcast bus may cause a RAF to decrement its local counter. A counter value of zero indicates that the graph is idle and a new graph could be configured.

While a zeroed result counter can mean that a new configuration should be injected, it can also mean that the current graph is idle and waiting for the next invocation. Thus, the counter hitting zero in the absence of a new configuration might not result in a change to the graph state.

Inter-RAF messaging can occur as soon as the RAF issues a result operation. Results do not need to have reached the tile manager, nor does the tile manager need to have completely processed the results. Additionally, RAFs do not have to be precisely synchronized in the reception of the inter-RAF messages, as the graph must have finished executing in order for any RAF to have achieved a zero counter.

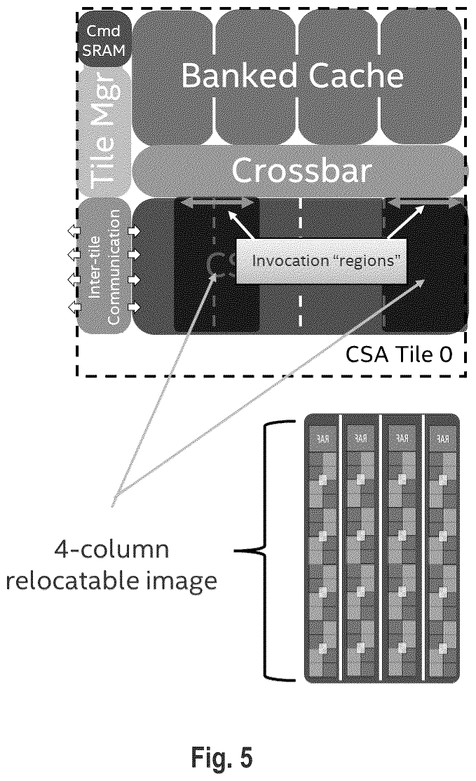

Hardware overhead for result tracking support is minimal. Counter size is expected to be less than 16 bits, while the inter-RAF broadcast bus will be of the order of one bit. As shown in FIG. 5, sub-tile partitioning may effectively create a range to which a result broadcast may occur. FIG. 5 shows an illustration of result broadcast regions for subtiles. The diagram shows a CSA Tile architecture including a “Banked Cache”, “Crossbar”, “Tile Manager”, and “Invocation Regions”. A “4-column relocatable image” is highlighted, and the “Subtile Boundary” is shown to confine the result broadcast, preventing it from propagating to other subtiles. Subtile boundaries may be annotated in the RAF configuration (for simplicity), and result broadcasts might not be propagated past the subtile boundary. This mechanism may extend to multi-tile graphs.

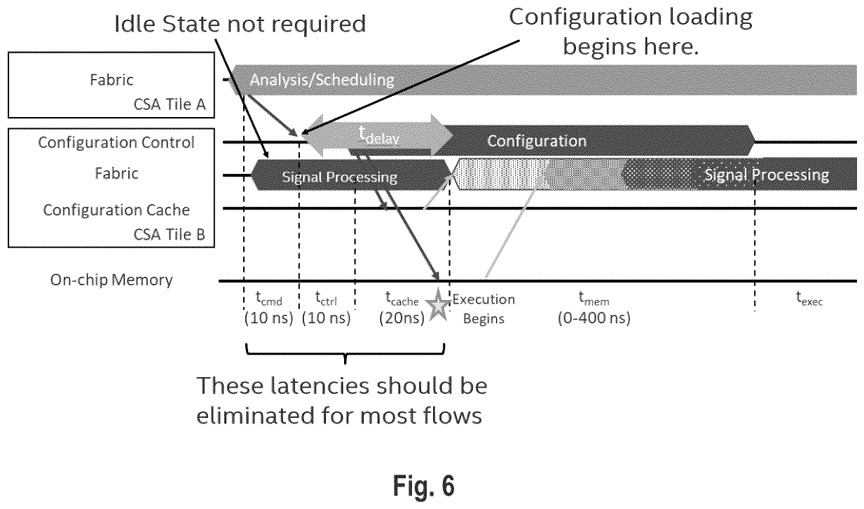

In the following, the performance of the separate buffers is evaluated. The prefetching effect of the separate configuration is highly valuable, as it overlaps configuration latencies with prior graph execution and graph termination-related tear-down activities. Critically, this effect can be achieved without software setup (e.g., pinning of critical configuration in CSA or configuration cache) in many cases. Of course, to reduce observed latency, configuration may commence prior to completion of the previous graph. To quantify how far in advance configuration must commence to realize minimum observed latency, the quantity t_{delay} is defined. t_{delay} is illustrated in FIG. 6 relative to program execution. Critically, t_{delay} is overlapped with prior signal processing execution. FIG. 6 shows an illustration of t_{delay} relative to an existing execution. If the execution is large enough, minimal latency will be observed. The diagram illustrates this relationship with three timelines: “Signal Processing (of the prior graph and the subsequent graph)”, “Configuration (of the subsequent graph)”, and the resulting observed latency t_{delay}. It visually demonstrates that as the start of configuration loading is advanced, the tdelay overlap with the prior graph's execution increases, which in turn reduces the final observed latency until a minimum is reached.

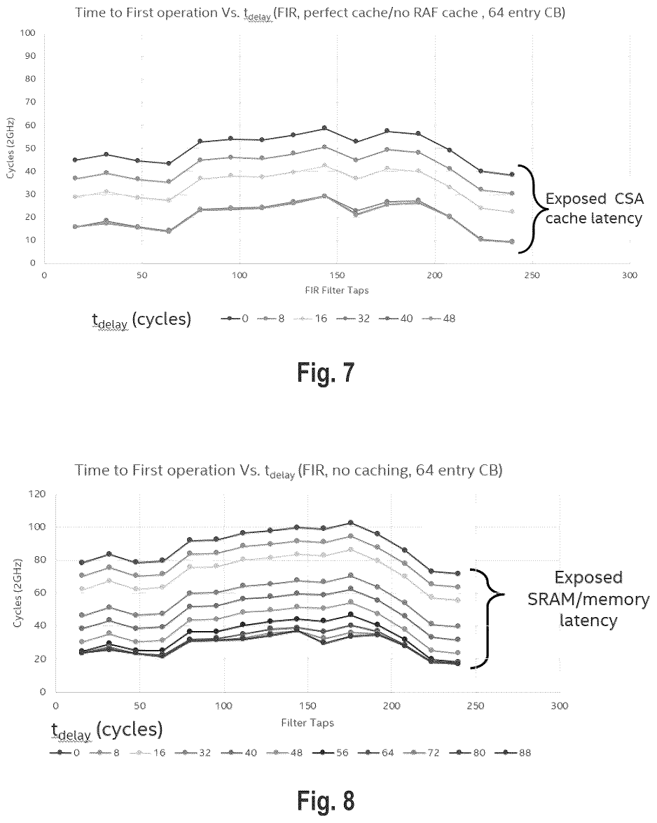

t_{delay} like most configuration-related timings is influenced by the positioning of configuration in memory. If configuration is in distant memory (e.g. off chip), t_{delay} will need to be larger, whereas if configuration is pinned in a local cache, t_{delay} can be smaller. In general, the value needed to observe minimal latency will be proportional to the bandwidth-latency product of the memory in which the configuration is resident. For graphs pinned in the main CSA cache, this value is around 30 cycles, as shown in FIG. 7. FIG. 7 shows time to first operation t_{delay} (in cycles) vs. FIR filter taps, assuming a perfect CSA cache.

These graphs indicate that relatively little advanced warning is required to achieve minimal latency. We expect most non-decision flows to be able to achieve tdelay values that are significantly longer than the minimum t_{delay} required to realize the minimum observed configuration latency.

The primary design consideration for the separate completion buffer is sizing. Generally, the completion buffer needs to be large enough to cover latency to memory, such that a continuous stream of configuration accesses can be sustained. We size the completion buffer in a zero t_{delay} scenario, as this provides pessimistic sizing of the buffer. In general, very small completion buffers are deleterious to observed latency as the configuration hardware is unable to sustain access bandwidth. However, even when configuration is in on-chip memory, as in FIG. 8, only 40×8 bytes are required to achieve a minimal observed latency. We are likely to provide a slightly larger buffer, as the processor-level impact of this buffer is very small. FIG. 8 shows t_{delay} vs. observed configuration latency assuming no cache locality and configuration is off-chip. Similar to FIG. 7, this graph plots l time to first operation t_{delay} (in cycles) vs. FIR filter taps.

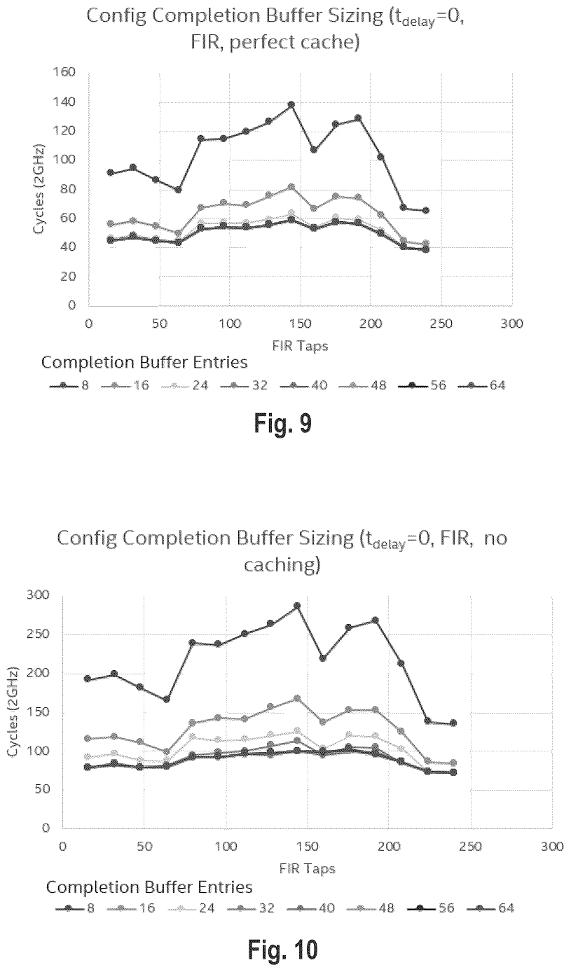

FIG. 9 shows an observed configuration latency vs. completion buffer entries, assuming a perfect CSA cache. FIG. 10 shows observed configuration latency vs. completion buffer entries, assuming configuration is in on-chip memory. Both graphs plot the latency (in cycles) versus FIR taps for various completion buffer times. A separate completion buffer with dual banks can allow for parallel configuration of EXA and RAF.

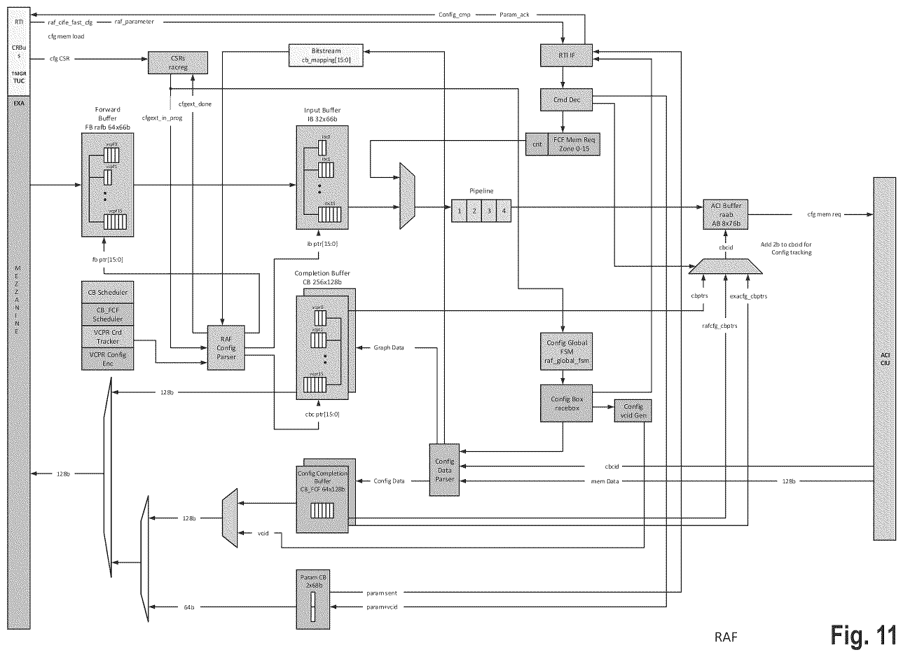

FIG. 11 shows a block diagram of a RAF with separate buffers. In FIG. 11, the configuration completion buffer (e.g., the first buffer (circuit)) is implemented separately from the completion buffer (e.g., the second buffer (circuit)). The diagram illustrates the data flow where the “Config Completion Buffer” and the main “Completion Buffer” are distinct blocks.

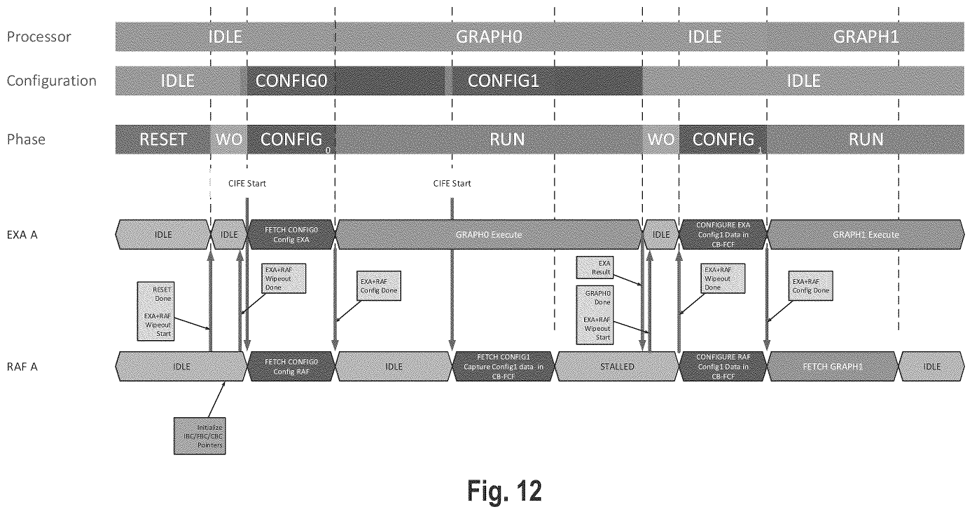

FIG. 12 shows a timing flow; some overlaps are not shown. It is evident from the second line, the configuration, that the subsequent configuration (CONFIG1) is stored in the configuration (completion) buffer while the present configuration (CONFIG0) is executed. The diagram displays timelines for the “Processor”, “Configuration”, “EXA A”, and “RAF A”. The “Processor” timeline shows the execution of “Run Cfg0”, while the “Configuration” timeline concurrently shows the “Fetch Cfg1” operation. This visualizes the core benefit of the split-buffer architecture: fetching the next configuration happens in parallel with the execution of the current one. The state transitions of EXA A and RAF A from IDLE to CONFIG and then to RUN are also depicted, corresponding to the configuration and execution phases.

A Configurable Spatial Accelerator (CSA) is a processor architecture built for high-performance computing. It is composed of a spatial array of processing elements (PEs) that are configured to directly execute a dataflow graph. Instead of processing a linear sequence of instructions, a CSA is programmed by mapping a dataflow graph—where nodes represent operations and edges represent data dependencies—onto its array of PEs. This structure enables a massive degree of parallelism, as numerous PEs can operate concurrently on the data flowing through the system. The architecture is intended to work with a compiler that can convert programs written in high-level languages into these executable dataflow graphs.

A Request Address File (RAF) is a circuit within the memory subsystem. Illustrations show the RAF positioned between the accelerator tiles and the system's cache banks. The RAF is responsible for managing memory requests originating from the processing elements. It plays a key role in organizing and tracking memory loads and stores to ensure data consistency across the system, a crucial task in a highly parallel architecture where many PEs may attempt to access memory simultaneously.

A completion buffer is a queue-like structure within the Request Address File (RAF) circuit. Its primary function is to reorder memory responses to ensure they are returned to the processing elements in the order that the requests were made. This is necessary because the memory subsystem can be out of order, meaning that it may not return data in the same sequence as it was requested. The completion buffer holds memory operations, such as loads, that have been scheduled but are awaiting data from memory. When a memory request is sent, a slot in the completion buffer is assigned to it. When the data returns from memory, it is stored in its assigned slot. The completion buffer then sends the results back to the local network in the original request order, thus maintaining the in-order semantics required by the accelerator's dataflow execution model.

A tile is a modular, fundamental building block of the accelerator architecture. It comprises a heterogeneous array of processing elements (PEs) linked together by a configurable interconnect network. An entire accelerator may be constructed from one or more of these tiles. For example, a larger tile may be composed of smaller sub-tiles. Each tile is capable of executing dataflow graphs, with its internal PEs performing the necessary computations and the interconnect managing the flow of data between them. This tiled design promotes scalability and modularity.

When the accelerator is configured with a dataflow graph, these components work in concert to execute the program. The dataflow graph is first mapped onto the array of processing elements (PEs) distributed across the system's tiles. Each PE is assigned a specific operation of the graph. Execution proceeds as data, represented as ‘tokens,’ flows between the PEs via the interconnect network in a data-driven fashion. If a PE requires data from external memory, it issues a request that is managed by the Request Address File (RAF), which handles the interaction with the cache and main memory. This entire system of interconnected tiles, operating on a dataflow paradigm, allows for a highly scalable and efficient method of computation.

The interface circuitry 102 or means for communicating 102 corresponds to one or more inputs and/or outputs designed to receive and/or transmit information. This information can be in digital (bit) values according to a specified code, whether exchanged within a module, between different modules, or even between modules of distinct entities. For example, the interface circuitry 102 or means for communicating 102 may include interface circuitry configured to handle the reception and/or transmission of such information.

For example, the processor circuitry 103 or means for processing 103 can be implemented using one or more processing units, processing devices, or any means for processing, such as a processor, a computer, or a programmable hardware component equipped with appropriately adapted software. Thus, the described function of the processor circuitry 103 or means for processing 103 can be executed in software, running on one or more programmable hardware components. Such components may include a general-purpose processor, a Digital Signal Processor (DSP), a microcontroller, and more.

In some embodiments, the memory circuitry 104 or means for storing information 104 may comprise at least one element of the group of a computer readable storage medium, such as an magnetic or optical storage medium, e.g., a hard disk drive, a flash memory, floppy disk, random access memory (RAM), programmable read only memory (PROM), erasable programmable read only memory (EPROM), an electronically erasable programmable read only memory (EEPROM), or a network storage.

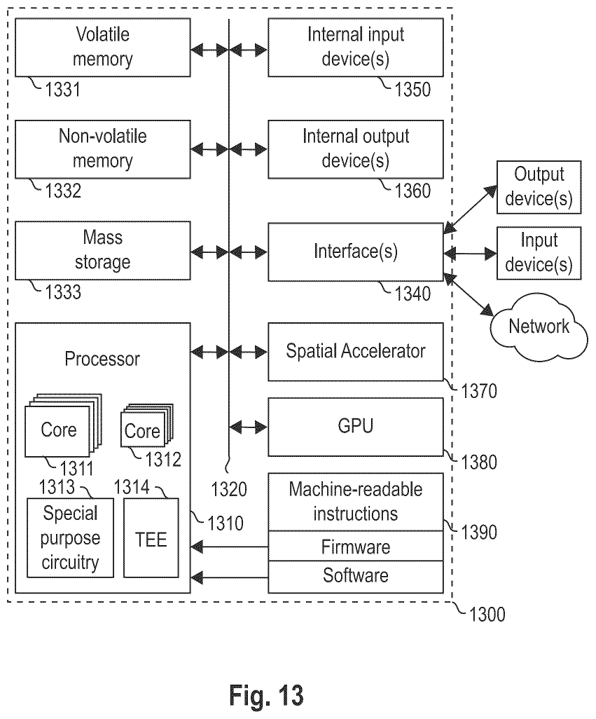

More details and aspects of the semiconductor apparatus 30, semiconductor device 30, computer system 100, and the corresponding methods and computer programs are mentioned in connection with the proposed concept or one or more examples described above or below (e.g., FIG. 13). The semiconductor apparatus 30, semiconductor device 30, computer system 100, and the corresponding methods and computer programs may comprise one or more additional optional features corresponding to one or more aspects of the proposed concept or one or more examples described above or below.

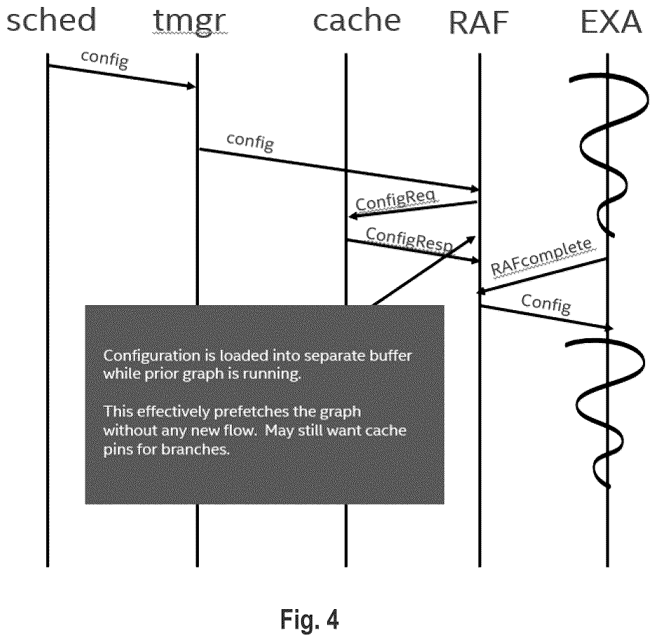

FIG. 13 shows a block diagram of an example computer system 1300 or computing device 1300 structured to execute and/or instantiate the machine-readable instructions and/or operations of FIGS. 1a to 12 to implement the computer system 100 and/or semiconductor apparatus or device 30. The computer system 1300 or computing device 1300 may be, for example, a server, a personal computer, a workstation, a self-learning machine (e.g., a neural network), a mobile device (e.g., a cell phone, a smartphone, a tablet such as an iPad™), a personal digital assistant (PDA), an Internet appliance, a DVD player, a CD player, a digital video recorder, a Blu-ray player, a gaming console, a personal video recorder, a set-top box, a headset (e.g., an augmented reality (AR) headset, a virtual reality (VR) headset, etc.) or other wearable device, or any other type of computing device.

The computer system 1300 or computing device 1300 of the illustrated example includes processor circuitry 1310. The processor circuitry 1310 of the illustrated example is hardware. For example, the processor circuitry 1310 can be implemented by one or more integrated circuits, logic circuits, FPGAs (Field-Programmable Gate Array), microprocessors, CPUs (Central Processing Units), GPUs (Graphics Processing Units), DSPs (Digital Signal Processors), and/or microcontrollers from any desired family or manufacturer. The processor circuitry 1310 may be implemented by one or more semiconductor-based (e.g., silicon-based) devices. For example, the processor circuitry 1310 may provide the functionality of the computer system 1300 or computing device 1300.

The processor circuitry 1310 comprises one or more processor cores 1311, 1312. For example, the processor circuitry 1310 may have heterogeneous cores. Heterogeneous cores in CPUs refer to the use of different types of cores within a single processor, typically combining high-performance (BIG) cores with power-efficient (LITTLE) cores. Thus, the processor circuitry 1310 may comprise one or more BIG cores 1311 and one or more LITTLE cores 1312. BIG cores are designed for performance-intensive tasks and provide higher processing power, but they consume more energy. LITTLE cores, on the other hand, are optimized for energy efficiency and handle less demanding tasks to prolong battery life and reduce power consumption.

The processor circuitry 1310 of the illustrated example is in communication, e.g., via one or more bus interfaces 1320, with a main memory including a volatile memory 1331 and a non-volatile memory 1332. The volatile memory 1331 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1332 may be implemented by flash memory and/or any other desired type of memory device. Access to the main memory 1331, 1332 of the illustrated example is controlled by a memory controller, which may be implemented by special-purpose circuitry 1313 of the processor circuitry 1310.

The computer system 1300 or computing device 1300 of the illustrated example also includes one or more mass storage devices 1333 to store software and/or data. Examples of such mass storage devices 1333 include magnetic storage devices, optical storage devices, floppy disk drives, HDDs, CDs, Blu-ray disk drives, redundant array of independent disks (RAID) systems, solid state storage devices such as flash memory devices, and DVD drives.

The computer system 1300 or computing device 1300 of the illustrated example also includes interface circuitry 1340. The interface circuitry 1340 may be implemented by hardware in accordance with any type of interface standard, such as an Ethernet interface, a WiFi interface, a cellular modem, a universal serial bus (USB) interface, a Bluetooth® interface, a near field communication (NFC) interface, a PCI (Peripheral Component Interconnect) interface, and/or a PCIe (Peripheral Component Interconnect Express) interface. For example, the interface circuitry 1340 of the illustrated example may include a communication device such as a transmitter, a receiver, a transceiver, a modem, a residential gateway, a wireless access point, and/or a network interface to facilitate exchange of data with external machines (e.g., computing devices of any kind) by a network. The communication can be by, for example, an Ethernet connection, a digital subscriber line (DSL) connection, a telephone line connection, a coaxial cable system, a satellite system, a line-of-site wireless system, a cellular telephone system, an optical connection, etc.

In the illustrated example, one or more internal input devices 1350 and/or one or more external input devices are connected to the interface circuitry 1340 or the bus 1320. The input device(s) permit a user to enter data and/or commands into the processor circuitry 1310. The input device(s) can be implemented by, for example, an audio sensor, a microphone, a camera (still or video), a keyboard, a button, a mouse, a touchscreen, a trackpad, a trackball, an isopoint device, and/or a voice recognition system.

One or more internal output devices 1360 and/or one or more external output devices are also connected to the interface circuitry 1340 of the illustrated example. The output devices 1360 can be implemented, for example, by display devices (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, a printer, and/or speaker. The computer system 1300 or computing device 1300 of the illustrated example, thus, typically includes a graphics driver card, a graphics driver chip, and/or graphics processor circuitry such as a GPU 1313, 1380, which may correspond to or be part of the processor circuitry 1310, for example as special purpose circuitry 1313 or as cores 1311, 1312, or separate from the processor 1310, for example as a separate GPU 1380.

The computer system 1300 or computing device 1300 of the illustrated example may include a Spatial Accelerator 1370 (e.g., the semiconductor apparatus or device 30). For example, the Spatial Accelerator 1370 may be configured to improve the computational speed and efficiency of specific tasks by executing parallel processing operations tailored to the respective tasks. The Spatial Accelerator 1370 may include hardware such as Processing Elements and an Interconnect Network designed to handle large volumes of data with low latency. For example, the Processor 1310, the Spatial Accelerator 1370 (e.g., the semiconductor apparatus or device 30), the integrated GPU 1313, and/or the dedicated GPU 1380 may be considered xPUs (x Processing Units, where x is a placeholder) of the computer system 700 or computing device 700.

The computer system 1300 or computing device 1300 of the illustrated example includes machine-readable instructions 1390. For example, the machine-readable instructions may be part of firmware or software of the computer system 1300 or computing device 1300. The machine-readable instructions 1390 may be stored in the mass storage device 1333, in the volatile memory 1331, in the non-volatile memory 1332, and/or on a removable non-transitory computer-readable storage medium such as a CD or DVD.

### In the Following, Some Examples of the Proposed Concept Are Presented:

An example (e.g., example 1) relates to a semiconductor apparatus comprising a spatial array of processing elements coupled by an interconnect network, a plurality of memory management circuits coupled to the spatial array of processing elements, wherein the respective memory management circuits comprise a first buffer circuit for storing a configuration to be used for configuring the processing elements associated with the respective memory management circuit and a second buffer circuit for storing results of computations performed by the processing elements associated with the respective memory management circuit, the first buffer circuit being separate from the second buffer circuit.

Another example (e.g., example 2) relates to a previous example (e.g., example 1) or to any other example, further comprising that the respective memory management circuits are configured to receive a subsequent configuration to be applied to the processing elements associated with the respective memory management circuit in a subsequent time interval while the processing elements associated with the respective memory management circuit are performing computations according to a present configuration.

Another example (e.g., example 3) relates to a previous example (e.g., one of the examples 1 or 2) or to any other example, further comprising that the respective memory management circuits are configured to use the first buffer circuit independently of the second buffer circuit.

Another example (e.g., example 4) relates to a previous example (e.g., one of the examples 1 to 3) or to any other example, further comprising that the respective memory management circuits are configured to detect that the processing elements associated with the respective memory management circuit have finished performing computations according to a present configuration, and to reconfigure the processing elements associated with the respective memory management circuit with the configuration stored in the first buffer circuit upon detection of the computations being finished.

Another example (e.g., example 5) relates to a previous example (e.g., example 4) or to any other example, further comprising that the detection is based on one or more of (a) a subsequent configuration being stored in the first buffer circuit, (b) the results of graph invocations having been returned to a managing entity, or (c) outstanding memory operations associated with a present graph having been completed.

Another example (e.g., example 6) relates to a previous example (e.g., one of the examples 4 or 5) or to any other example, further comprising that the respective memory management apparatuses comprise a counter of outstanding results, with the detection of the computations being finished being based on the counter of outstanding results.

Another example (e.g., example 7) relates to a previous example (e.g., one of the examples 1 to 6) or to any other example, further comprising that the first buffer circuit comprises a first and a second buffer bank, the configuration comprises a first configuration portion relevant for the respective memory management apparatus and a second configuration portion relevant for the processing elements associated with the memory management apparatus, and the respective memory management apparatuses are configured to receive the configuration to be stored in the first and second buffer bank, and store the first configuration portion in the first buffer bank and at least a portion of the second configuration portion in the second buffer bank.

Another example (e.g., example 8) relates to a previous example (e.g., example 7) or to any other example, further comprising that the respective memory management apparatuses are configured to store the first configuration portion in the first buffer bank, subsequently store the second configuration portion in the second buffer bank until the second buffer bank is filled, and thereafter store a remaining part of the second configuration portion in the first buffer bank.

Another example (e.g., example 9) relates to a previous example (e.g., one of the examples 7 or 8) or to any other example, further comprising that the first and second buffer banks have a width that matches the bandwidth of a communication interface.

Another example (e.g., example 10) relates to a previous example (e.g., one of the examples 7 to 9) or to any other example, further comprising that the semiconductor apparatus comprises multiplexing circuitry configured to align the first and second configuration portions for storage in the first and second buffer banks.

Another example (e.g., example 11) relates to a previous example (e.g., one of the examples 1 to 10) or to any other example, further comprising that the first buffer circuit has a smaller storage capacity than the second buffer circuit.

An example (e.g., example 12) relates to a semiconductor device comprising a spatial array of processing elements coupled by an interconnect network, a plurality of means for memory management coupled to the spatial array of processing elements, wherein the respective means for memory management comprise a first buffer for storing a configuration to be used for configuring the processing elements associated with the respective means for memory management and a second buffer for storing results of computations performed by the processing elements associated with the respective means for memory management, the first buffer being separate from the second buffer.

Another example (e.g., example 13) relates to a previous example (e.g., example 12) or to any other example, further comprising that the respective means for memory management are configured to receive a subsequent configuration to be applied to the processing elements associated with the respective means for memory management in a subsequent time interval while the processing elements associated with the respective means for memory management are performing computations according to a present configuration.

Another example (e.g., example 14) relates to a previous example (e.g., one of the examples 12 or 13) or to any other example, further comprising that the respective means for memory management are configured to use the first buffer independently of the second buffer.

Another example (e.g., example 15) relates to a previous example (e.g., one of the examples 12 to 14) or to any other example, further comprising that the respective means for memory management are configured to detect that the processing elements associated with the respective means for memory management have finished performing computations according to a present configuration, and to reconfigure the processing elements associated with the respective means for memory management with the configuration stored in the first buffer upon detection of the computations being finished.

Another example (e.g., example 16) relates to a previous example (e.g., example 15) or to any other example, further comprising that the detection is based on one or more of (a) a subsequent configuration being stored in the first buffer, (b) the results of graph invocations having been returned to a managing entity, or (c) outstanding memory operations associated with a present graph having been completed.

Another example (e.g., example 17) relates to a previous example (e.g., one of the examples 15 or 16) or to any other example, further comprising that the respective means for memory management comprise a counter of outstanding results, with the detection of the computations being finished being based on the counter of outstanding results.

Another example (e.g., example 18) relates to a previous example (e.g., one of the examples 12 to 17) or to any other example, further comprising that the first buffer comprises a first and a second buffer bank, the configuration comprises a first configuration portion relevant for the respective memory management device and a second configuration portion relevant for the processing elements associated with the memory management device, and the respective means for memory management are configured to receive the configuration to be stored in the first and second buffer bank, and store the first configuration portion in the first buffer bank and at least a portion of the second configuration portion in the second buffer bank.

Another example (e.g., example 19) relates to a previous example (e.g., example 18) or to any other example, further comprising that the respective means for memory management are configured to store the first configuration portion in the first buffer bank, subsequently store the second configuration portion in the second buffer bank until the second buffer bank is filled, and thereafter store a remaining part of the second configuration portion in the first buffer bank.

Another example (e.g., example 20) relates to a previous example (e.g., one of the examples 18 or 19) or to any other example, further comprising that the first and second buffer banks have a width that matches the bandwidth of a communication interface.

Another example (e.g., example 21) relates to a previous example (e.g., one of the examples 18 to 20) or to any other example, further comprising that the semiconductor device comprises a multiplexer configured to align the first and second configuration portions for storage in the first and second buffer banks.

Another example (e.g., example 22) relates to a previous example (e.g., one of the examples 12 to 21) or to any other example, further comprising that the first buffer has a smaller storage capacity than the second buffer.

An example (e.g., example 23) relates to a non-transitory computer-readable medium storing instructions that, when executed by one or more processing circuitries, cause the one or more processing circuitries to perform a method for a computer system, the method comprising determining a configuration for a semiconductor apparatus, the semiconductor apparatus comprising a spatial array of processing elements coupled by a interconnect network and a plurality of memory management circuits coupled to the spatial array of processing elements, wherein the respective memory management circuits comprise a first buffer circuit for storing a configuration to be used for configuring the processing elements associated with the respective memory management circuit and a second buffer circuit for storing results of computations performed by the processing elements associated with the respective memory management circuit, the first buffer circuit being separate from the second buffer circuit, providing the configuration for the first buffer circuit, and obtaining the result of the computations of the second buffer circuit.

Another example (e.g., example 24) relates to a previous example (e.g., example 23) or to any other example, further comprising that the method comprises providing a subsequent configuration to the first buffer circuit of the respective memory management circuits while the processing elements associated with the respective memory management circuit are performing computations according to a present configuration.

An example (e.g., example 25) relates to a method for a computer system, the method comprising determining (110) a configuration for a semiconductor apparatus, the semiconductor apparatus comprising a spatial array of processing elements coupled by a interconnect network and a plurality of memory management circuits coupled to the spatial array of processing elements, wherein the respective memory management circuits comprise a first buffer circuit for storing a configuration to be used for configuring the processing elements associated with the respective memory management circuit and a second buffer circuit for storing results of computations performed by the processing elements associated with the respective memory management circuit, the first buffer circuit being separate from the second buffer circuit, providing (120) the configuration for the first buffer circuit, and obtaining (130) the result of the computations of the second buffer circuit.

Another example (e.g., example 26) relates to a previous example (e.g., example 26) or to any other example, further comprising that the method comprises providing (140) a subsequent configuration to the first buffer circuit of the respective memory management circuits while the processing elements associated with the respective memory management circuit are performing computations according to a present configuration.

Another example (e.g., example 27) relates to an apparatus for a computer system, comprising interface circuitry, machine-readable instructions, and processor circuitry to execute the machine-readable instructions to perform the method according to one of the examples 25 or 26 (or according to any other example).

Another example (e.g., example 28) relates to a device for a computer system, comprising means for communicating, machine-readable instructions, and means for processing to execute the machine-readable instructions to perform the method according to one of the examples 25 or 26 (or according to any other example).

Another example (e.g., example 29) relates to a computer system comprising the semiconductor apparatus or semiconductor device according to one of the examples 1 to 22(or according to any other example).

Another example (e.g., example 30) relates to the computer system according to example 39,further comprising the apparatus or device according to one of the examples 27 or 28 (or according to any other example).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A semiconductor apparatus comprising:
a spatial array of processing elements coupled by an interconnect network;
a plurality of memory management circuits coupled to the spatial array of processing elements,
wherein the respective memory management circuits comprise a first buffer circuit for storing a configuration to be used for configuring the processing elements associated with the respective memory management circuit and a second buffer circuit for storing results of computations performed by the processing elements associated with the respective memory management circuit, the first buffer circuit being separate from the second buffer circuit.

2. The semiconductor apparatus according to claim 1, wherein the respective memory management circuits are configured to receive a subsequent configuration to be applied to the processing elements associated with the respective memory management circuit in a subsequent time interval while the processing elements associated with the respective memory management circuit are performing computations according to a present configuration.

3. The semiconductor apparatus according to claim 1, wherein the respective memory management circuits are configured to use the first buffer circuit independently of the second buffer circuit.

4. The semiconductor apparatus according to claim 1, wherein the respective memory management circuits are configured to detect that the processing elements associated with the respective memory management circuit have finished performing computations according to a present configuration, and to reconfigure the processing elements associated with the respective memory management circuit with the configuration stored in the first buffer circuit upon detection of the computations being finished.

5. The semiconductor apparatus according to claim 4, wherein the detection is based on one or more of (a) a subsequent configuration being stored in the first buffer circuit, (b) the results of graph invocations having been returned to a managing entity, or (c) outstanding memory operations associated with a present graph having been completed.

6. The semiconductor apparatus according to claim 4, wherein the respective memory management apparatuses comprise a counter of outstanding results, with the detection of the computations being finished being based on the counter of outstanding results.

7. The semiconductor apparatus according to claim 1, wherein the first buffer circuit comprises a first and a second buffer bank, the configuration comprises a first configuration portion relevant for the respective memory management apparatus and a second configuration portion relevant for the processing elements associated with the memory management apparatus, and the respective memory management apparatuses are configured to receive the configuration to be stored in the first and second buffer bank, and store the first configuration portion in the first buffer bank and at least a portion of the second configuration portion in the second buffer bank.

8. The semiconductor apparatus according to claim 7, wherein the respective memory management apparatuses are configured to store the first configuration portion in the first buffer bank, subsequently store the second configuration portion in the second buffer bank until the second buffer bank is filled, and thereafter store a remaining part of the second configuration portion in the first buffer bank.

9. The semiconductor apparatus according to claim 7, wherein the first and second buffer banks have a width that matches the bandwidth of a communication interface.

10. The semiconductor apparatus according to claim 7, wherein the semiconductor apparatus comprises multiplexing circuitry configured to align the first and second configuration portions for storage in the first and second buffer banks.

11. The semiconductor apparatus according to claim 1, wherein the first buffer circuit has a smaller storage capacity than the second buffer circuit.

12. A computer system comprising the semiconductor apparatus according to claim 1.

13. A non-transitory computer-readable medium storing instructions that, when executed by one or more processing circuitries, cause the one or more processing circuitries to perform a method for a computer system, the method comprising:
determining a configuration for a semiconductor apparatus, the semiconductor apparatus comprising a spatial array of processing elements coupled by a interconnect network and a plurality of memory management circuits coupled to the spatial array of processing elements, wherein the respective memory management circuits comprise a first buffer circuit for storing a configuration to be used for configuring the processing elements associated with the respective memory management circuit and a second buffer circuit for storing results of computations performed by the processing elements associated with the respective memory management circuit, the first buffer circuit being separate from the second buffer circuit;
providing the configuration for the first buffer circuit; and
obtaining the result of the computations of the second buffer circuit.

14. The non-transitory computer-readable medium according to claim 13, wherein the method comprises providing a subsequent configuration to the first buffer circuit of the respective memory management circuits while the processing elements associated with the respective memory management circuit are performing computations according to a present configuration.

15. An apparatus for a computer system, comprising interface circuitry, machine-readable instructions, and processor circuitry to execute the machine-readable instructions to:
determine a configuration for a semiconductor apparatus, the semiconductor apparatus comprising a spatial array of processing elements coupled by a interconnect network and a plurality of memory management circuits coupled to the spatial array of processing elements, wherein the respective memory management circuits comprise a first buffer circuit for storing a configuration to be used for configuring the processing elements associated with the respective memory management circuit and a second buffer circuit for storing results of computations performed by the processing elements associated with the respective memory management circuit, the first buffer circuit being separate from the second buffer circuit;
provide the configuration for the first buffer circuit; and
obtain the result of the computations of the second buffer circuit.

16. The apparatus according to claim 15, wherein the processor circuitry is to execute the machine-readable instructions to provide a subsequent configuration to the first buffer circuit of the respective memory management circuits while the processing elements associated with the respective memory management circuit are performing computations according to a present configuration.
